(19) United States
(12) Patent Application Publication
(10) Pub. No.: US 2026/0235361 A1
(43) Pub. Date: Aug. 13, 2026

(54) METHOD FOR DETERMINING SLAB LENGTH AND SLAB CHARGING POSITION WITHIN WALKING-BEAM HEATING FURNACE

(71) Applicant: JFE STEEL CORPORATION, Chiyoda-ku, Tokyo (JP)

(72) Inventors: Tomoyoshi OGASAHARA, Chiyoda-ku, Tokyo (JP); Yukihiro SHINGAKI, Chiyoda-ku, Tokyo (JP); Takahiro AKAZAWA, Chiyoda-ku, Tokyo (JP); Ryota KUBOMURA, Chiyoda-ku, Tokyo (JP); Yushi HARADA, Chiyoda-ku, Tokyo (JP); Masaaki TAKATA, Chiyoda-ku, Tokyo (JP); Takayuki FUKUNAGA, Chiyoda-ku, Tokyo (JP)

(73) Assignee: JFE STEEL CORPORATION, Chiyoda-ku, Tokyo (JP)

(21) Appl. No.: 19/470,989

(22) PCT Filed: Mar. 27, 2024
(86) PCT No.: PCT/JP2024/012502

§ 371 Date: Sep. 30, 2025

(30) Foreign Application Priority Data
Apr. 19, 2023 (JP) 2023-068887

(51) Int. Cl. F27B 9/20; F27B 9/38

(52) U.S. Cl. CPC F27B 9/201; F27B 2009/382

(57) ABSTRACT

A method of determining the slab length and charging position of a slab in a walking-beam heating furnace uses a constraint equation defining an overhang amount, a constraint equation defining a scab defect occurrence probability corresponding to the overhang amount, and a constraint equation defining upper and lower limits of the slab length, and determines the length of the slab and the charging position of the slab. As the overhang amount, a lead end overhang amount, defined as a distance between a lead end coordinate of the slab in the heating furnace and a second skid coordinate counted from a lead end in a tail end direction, and a tail end overhang amount, defined as a distance between a tail end coordinate of the slab in the heating furnace and a second skid coordinate counted from a tail end in a lead end direction, are used.

### TECHNICAL FIELD

The present disclosure relates to a walking-beam heating furnace installed in a hot rolling mill or thick plate mill for producing steel plates, and relates to a method of determining the length of a slab to be charged into such a heating furnace and the charging position of the slab.

### BACKGROUND

In a hot rolling mill, slabs received from continuous casting and the like are heated in a walking-beam heating furnace to a predetermined extraction temperature (approximately 1050° C. to 1200° C.), and then undergo rough rolling, finishing rolling, run-out table cooling, and coiling to produce hot-rolled coils.

In a walking-beam heating furnace, the slab is lifted by a moving skid while having been heated to a high temperature.

During such lifting, the slab may droop due to creep deformation from the support point to the leading/tail ends, and when this part comes into contact with the fixed skid part on the outside when the slab is lowered from the moving skid, scab defects can occur.

Alternatively, if the moving skid is on the outermost side, when the slab is lowered and the moving skid is retracting, a sagging portion may be generated as a cantilever due to the fixed skid, and this sagging portion may come into contact with the moving skid that has returned to its fixed position, resulting in scab defects.

Such creep deformation that occurs at high temperatures tends to be less likely to occur in general steel that is in the austenite phase at high temperatures, and is more likely to occur in grain-oriented electrical steel sheets that are in the ferrite phase at high temperatures. Moreover, the amount of deformation due to this creep deformation increases under conditions such as a long distance (overhang amount) from the support point to the slab end, or a slab that is thin or at a high temperature, which makes scab defects more likely to occur, as described in Patent Literature (PTL) 1.

Generally, the thickness and width of the slab and the heating conditions in the heating furnace are designed according to standards and have little room for change, but the slab length can sometimes be adjusted to a certain extent. Therefore, it is conceivable to utilize the slab length as a means of adjusting the overhang amount.

Also, typically, the plurality of heating furnaces in a hot rolling mill do not all necessarily have the same skid arrangement. As a result, even with the same slab length, the overhang amount often varies depending on the heating furnace. Furthermore, if there is a skid shift structure, the overhang amount can change even within the same heating furnace.

Thus, a slab length with a small overhang amount in one heating furnace may have a longer overhang amount in another heating furnace, complicating the design of the slab length.

In response to this, PTL 1 discloses a method of avoiding contact defects that occur due to creep deformation when a discharge fork is inserted at the time of extraction from the heating furnace.

### CITATION LIST

### Patent Literature

PTL 1: JP H06-346132 A

### SUMMARY

### Technical Problem

However, PTL 1 does not disclose a method of designing the slab length and charging position to suppress the occurrence of scab defects that occur at the aforementioned skid part.

The present disclosure has been made in view of the above circumstances and aims to provide a method of designing the slab length and charging position of a slab to be charged into a walking-beam heating furnace so as to minimize the probability of occurrence of scab defects at the skid part. Furthermore, the present disclosure aims to provide a design method that minimizes the probability of occurrence of scab defects in the case of a plurality of walking-beam heating furnaces.

### Solution to Problem

(1) A method of determining a slab length and a charging position of a slab in a walking-beam heating furnace according to an embodiment of the present disclosure is
a method of determining a slab length and a charging position of a slab in a walking-beam heating furnace, the method including, in determining a length of a slab to be charged into at least one walking-beam heating furnace and a charging position of the slab using mixed integer programming, using, as constraint conditions, a constraint equation defining an overhang amount, a constraint equation defining a scab defect occurrence probability corresponding to the overhang amount from a predetermined model that defines a relationship between the overhang amount and a probability of occurrence of a scab defect occurring at a skid portion, and a constraint equation defining upper and lower limits of slab length, further using an evaluation function that uses a constraint equation defining the scab defect occurrence probability, and determining the length of the slab and the charging position of the slab to minimize the evaluation function under the constraint conditions, wherein
as the overhang amount, a lead end overhang amount, defined as a distance between a lead end coordinate of the slab in the heating furnace and a second skid coordinate counted from a lead end in a tail end direction, and a tail end overhang amount, defined as a distance between a tail end coordinate of the slab in the heating furnace and a second skid coordinate counted from a tail end in a lead end direction, are used.
(2) As an embodiment of the present disclosure, in (1),
in a case in which the walking-beam heating furnace includes a shift function, as the overhang amount, a pre-shift lead end overhang amount, defined as a distance between the lead end coordinate of the slab in the heating furnace and a second pre-shift skid coordinate counted from the lead end in the tail end direction, a pre-shift tail end overhang amount, defined as a distance between the tail end coordinate of the slab in the heating furnace and a second pre-shift skid coordinate counted from the tail end in the lead end direction, a post-shift lead end overhang amount, defined as a distance between the lead end coordinate of the slab in the heating furnace and a second post-shift skid coordinate counted from the lead end in the tail end direction, and a post-shift tail end overhang amount, defined as a distance between the tail end coordinate of the slab in the heating furnace and a second post-shift skid coordinate counted from the tail end in the lead end direction, are used.
(3) As an embodiment of the present disclosure, in (1) or (2),
in a case in which the at least one walking-beam heating furnace comprises a plurality of walking-beam heating furnaces, an equality constraint on the slab length for the heating furnaces is added to the constraint conditions.
(4) As an embodiment of the present disclosure, in any one of (1) to (3),
the constraint equation defining the scab defect occurrence probability is selected according to a maximum end-point temperature of the slab obtained in advance.
(5) As an embodiment of the present disclosure, in any one of (1) to (4),
the evaluation function is the sum of the square of each scab defect occurrence probability.
(6) As an embodiment of the present disclosure, in any one of (1) to (4),
the evaluation function is the sum of each scab defect occurrence probability.

### Advantageous Effect

According to the present disclosure, the yield rate improves by reducing the occurrence probability of scab defects occurring in the skid section.

### BRIEF DESCRIPTION OF THE DRAWINGS

In the accompanying drawings:

FIG. 1 is a diagram illustrating the implementation flow of an embodiment of the present disclosure;

FIG. 2 is a diagram illustrating the relationship between the lead end coordinate and the overhang amount;

FIG. 3 is a diagram illustrating an overhang amount-dependent model of scab defect occurrence probability; and

FIG. 4 is a diagram illustrating the scab defect occurrence probability model.

### DETAILED DESCRIPTION

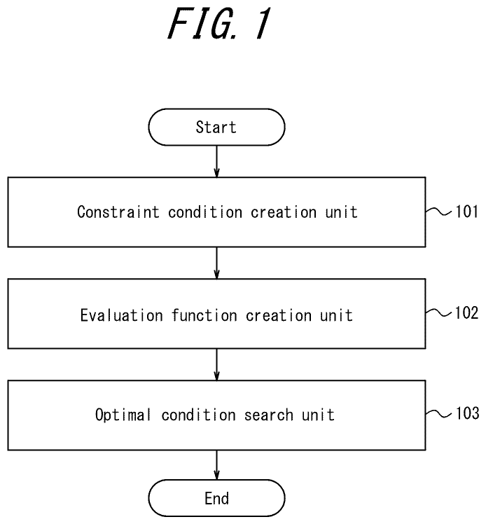

Based on the implementation flow illustrated in FIG. 1, an embodiment of the present disclosure is explained. Here, the present embodiment is a method used for a walking-beam heating furnace (hereinafter also simply referred to as a “heating furnace”) that heats slabs for steel plates received from continuous casting and the like.

Hereinafter, an explanation is provided for a plurality of heating furnaces installed in the same factory, with the heating furnaces performing one shift during heating. In the case of using a heating furnace without a shift, the explanation regarding the post-shift can be omitted in the following description. Also, such a plurality of heating furnaces in the same factory can be considered collectively in the present embodiment, but even in the case of a single heating furnace, by aligning the numbers of the following subscripts and the like to one heating furnace, the following method can be applied.

Furthermore, the method of the present embodiment uses mixed integer programming in determining the length of the slab and the charging position of the slab, and the specific procedure will be explained below.

First, in a constraint condition creation unit (101) illustrated in FIG. 1, equality and inequality constraints are created. The equality and inequality constraints define the pre-shift lead end overhang amount, pre-shift tail end overhang amount, post-shift lead end overhang amount, post-shift tail end overhang amount, slab length, and scab defect occurrence probability for each heating furnace.

As a specific procedure, an inequality constraint defining the pre-shift lead end overhang amount for a certain heating furnace is explained. As preparation, for a case in which the furnace has N skids, constants including the skid coordinates listed in Table 1 below are read.

TABLE 1

| Symbol | Description |
|---|---|
| wᵢ (i = 1, . . . , N + 2) | w₁: stores −M (M is a real value, and is a considerably larger value than w_{N+1}) |
| | w₂ . . . w_{N+1}: stores skid coordinates in ascending order |
| | w_{N+2}: stores M (M is a real value and is considerably larger than w_{N+1}) |

Next, the decision variables listed in Table 2 below are prepared.

TABLE 2

| Symbol | Description |
|---|---|
| x_{LE} | Pre-shift lead end coordinate |
| zᵢ (i = 1, . . . , N + 1) | Binary variable that takes 1 when x_{LE} is between wᵢ and wᵢ₊₁, otherwise takes 0 |
| tᵢ (i = 1, . . . , N + 2) | Continuous variable used in equality constraint for lead end coordinate x_{LE}, representing weight for wᵢ |
| Lᵢ (i = 1, . . . , N + 1) | Distance of x_{LE} from wᵢ |
| Lᵢ′ (i = 1, . . . , N + 1) | Variable taking larger of Lᵢ and 0 |
| δᵢ (i = 1, . . . , N + 1) | Binary variable taking 1 if Lᵢ is greater than 0 and taking 0 if Lᵢ is less than 0 |
| Dᵢ (i = 1, . . . , N + 1) | Variable Dᵢ taking L′ᵢ₋₁ if zᵢ is 1 and taking 0 if zᵢ is 0 |
| O_{LE1} | Pre-shift lead end overhang amount |

Let x_{LE} listed in Table 2 be represented by the equality constraint (1a) below, using the skid coordinate wᵢ and the continuous variable tᵢ of the index.

$$\begin{matrix}[ Math . 1 ] & \\ {x}_{LE} = {\sum }_{i = 1}^{N + 2} {w}_{i} {t}_{i} & ( 1 a )\end{matrix}$$

Here, (1a) means that the continuous variables tᵢ of at most adjacent indices are positive, and their sum is 1, thus determining the coordinates as the internal division point of the skid coordinates. Therefore, at this time, the inequalities that the binary variable zᵢ (i=1, 2, . . . , N+1) and the continuous variable tᵢ (i=1, . . . , N+2) must satisfy become Expressions (1b) to (1e) below.

$$\begin{matrix}[ Math . 2 ] & \\ \begin{matrix}{t}_{1} \leq {z}_{1} \\ {t}_{2} \leq {z}_{1} + {z}_{2} \\ {t}_{3} \leq {z}_{2} + {z}_{3} \\ ⋮ \\ {t}_{N + 1} \leq {z}_{N} + {z}_{N + 1} \\ {t}_{N + 2} \leq {z}_{N + 1}\end{matrix} & ( 1 b )\end{matrix}$$

$$\begin{matrix}{t}_{1} \geq 0 \\ {t}_{2} \geq 0 \\ ⋮ \\ {t}_{N + 2} \geq 0\end{matrix} \qquad ( 1 c )$$

$${\sum }_{ì = 1}^{N + 2} {t}_{i} = 1 \qquad ( 1 d )$$

$${\sum }_{i = 1}^{N + 1} {z}_{i} = 1 \qquad ( 1 e )$$

Next, the distance Lᵢ from the skid coordinate wᵢ to the lead end coordinate x_{LE} is expressed by the following equality constraint (1f).

$$\begin{matrix}[ Math . 3 ] & \\ {L}_{i} = {X}_{LE} - {w}_{i} , ( i = 1 , 2 , … , N + 1 ) & ( 1 f )\end{matrix}$$

Here, an inequality is constructed so that the decision variable Lᵢ′ takes Lᵢ if Lᵢ is greater than 0, and takes 0 if Lᵢ is 0 or less. Through the binary variable δᵢ, which takes values according to the sign of Lᵢ, an inequality is created to select either Lᵢ or 0.

That is, the inequality that the binary variable δᵢ must satisfy, which takes 1 if Lᵢ is greater than 0 and 0 if Lᵢ is 0 or less, is given by the following Expression (1g).

$$\begin{matrix}[ Math . 4 ] & \\ - M ( 1 - {δ}_{i} ) + ε \leq {L}_{i} & ( 1 g )\end{matrix}$$

$${L}_{i} \leq M {δ}_{i}$$

$$( i = 1 , 2 , , … , N + 1 )$$

Therefore, the decision variable Lᵢ′ that takes the larger value of Lᵢ and 0 is expressed by the following Expression (1h) using Lᵢ and δᵢ.

$$\begin{matrix}[ Math . 5 ] & \\ {L}_{i} - ( 1 - δ ) M \leq {L}_{i}^{′} \leq {L}_{i} + ( 1 - δ ) M & ( 1 h )\end{matrix}$$

$$- δ M \leq {L}_{i}^{′} \leq δ M$$

$$( i = 1 , 2 , , … , N + 1 )$$

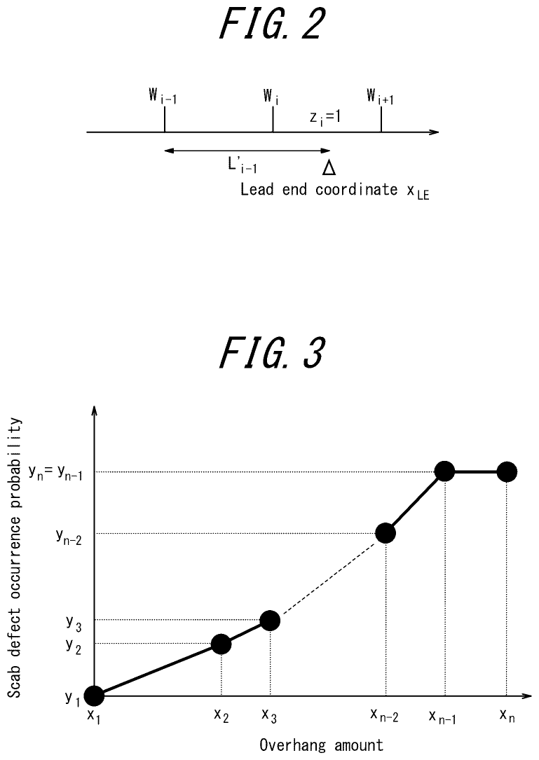

Next, as illustrated in FIG. 2, when the lead end coordinate x_{LE} is between wᵢ and wᵢ₊₁, the overhang amount becomes Lᵢ₋₁′. Lᵢ₋₁′ is the lead end overhang amount, which is the distance between the lead end coordinate of the slab in the heating furnace and the second skid coordinate counted from the lead end in the tail end direction. To express this, the variable Dᵢ, which takes Lᵢ₋₁′ if zᵢ is 1 and 0 if zᵢ is 0, must satisfy the following Inequality (1i). The overhang amount O_{LE1} can be expressed by the equality constraint of Expression (1j).

The above are the equalities and inequalities for the pre-shift lead end overhang amount.

Here, if the lead end overhang amount is defined as the distance from the lead end coordinate of the slab in the heating furnace to the first skid coordinate counted from the lead end in the tail end direction, then no effect is obtained, as illustrated in the EXAMPLES section described later. On the other hand, there is no need to consider defining the lead end overhang amount as the distance from the lead end coordinate of the slab in the heating furnace to the third (or subsequent) skid coordinate counted from the lead end in the tail end direction. The reason is that as a physical phenomenon, creep deformation progresses in a cantilever state due to the second skid.

$$\begin{matrix}[ Math . 6 ] & \\ 0 \leq {D}_{i} \leq {Mz}_{i} & ( 1 i )\end{matrix}$$

$${L}_{i - 1}^{′} - ( 1 - {z}_{i} ) M \leq {D}_{i} \leq {L}_{i - 1}^{′}$$

$$( i = 2 , … , N + 1 )$$

$${O}_{LE 1} = {\sum }_{i = 2}^{N + 1} {D}_{i} \qquad ( 1 j )$$

Next, in a similar manner, equalities and inequalities that the pre-shift tail end overhang amount should satisfy are constructed. Letting the tail end coordinate at this time be x_{TE}, the slab length L_{slab} is expressed by Equality (2) below along with the lead end coordinate x_{LE}.

$$\begin{matrix}[ Math . 7 ] & \\ {L}_{slab} = {x}_{LE} - {x}_{TE} & ( 2 )\end{matrix}$$

Regarding the slab length L_{slab}, upper and lower limit constraints are defined. When the upper limit is L^{U}_{slab} and the lower limit is L^{L}_{slab}, the slab length L_{slab} is given by Inequality (3) below.

$$\begin{matrix}[ Math . 8 ] & \\ {L}_{slab}^{L} \leq {L}_{slab} \leq {L}_{slab}^{U} & ( 3 )\end{matrix}$$

Next, equalities and inequalities that the post-shift lead and tail end overhang amounts should satisfy are constructed in the same manner as above. Here, since the lead end coordinate x_{LE} and the tail end coordinate x_{TE} already defined by the post-shift lead and tail end overhang amounts do not change after the shift, the lead end coordinate x_{LE} and the tail end coordinate x_{TE} can be used as they are.

Next, the inequality constraint that defines the scab defect occurrence probability is explained.

The relationship between the overhang amount and the scab defect occurrence probability is modeled in advance, as illustrated in FIG. 3. Such a model is, for example, constructed as a piecewise linear model pairing the overhang amount with the corresponding scab defect occurrence probability, as illustrated in Table 3.

TABLE 3

| Symbol | Description |
|---|---|
| xᵢ (i = 1, . . . , n) | Overhang amount |
| yᵢ (i = 1, . . . , n) | Scab defect occurrence probability corresponding to xᵢ |

Next, when the pre- and post-shift leading and tail end overhang amounts of each heating furnace (heating furnace number j) are given as illustrated in Table 4 below, an inequality that defines the corresponding scab defect occurrence probability is constructed. As an example, a method of calculating the scab defect occurrence probability corresponding to the pre-shift lead end overhang amount O_{LE1,j} is explained.

$$\begin{matrix}[ Math . 9 ] & \\ {O}_{LE 1 , j} = {\sum }_{i = 1}^{n} {x}_{i} {s}_{i , j} & ( 4 a )\end{matrix}$$

TABLE 4

| Symbol | Meaning |
|---|---|
| O_{LE1, j} | Pre-shift lead end overhang amount |
| O_{TE1, j} | Pre-shift tail end overhang amount |
| O_{LE2, j} | Post-shift lead end overhang amount |
| O_{TE2, j} | Post-shift tail end overhang amount |

TABLE 5

| Symbol | Description |
|---|---|
| d_{i, j} (i = 1, . . . , n − 1) | Binary variable taking 1 when O_{LE1, j} is between xᵢ and xᵢ₊₁, otherwise taking 0 |
| s_{i, j} (i = 1, . . . , n) | Used for the equality constraint O_{LE1, j}. Continuous variable representing weight for xᵢ, yᵢ |
| P_{LE1, j} | Scab defect occurrence probability at pre-shift lead end |
| P_{TE1, j} | Scab defect occurrence probability at pre-shift tail end |
| P_{LE2, j} | Scab defect occurrence probability at post-shift lead end |
| P_{TE2, j} | Scab defect occurrence probability at post-shift tail end |

If O_{LE1,j} is represented by the equality constraint (4a), this means that the continuous variables s_{i,j} of at most adjacent indices are positive, and their sum is 1, thus determining the coordinates as the internal division point of the skid coordinates. At this time, the inequalities that the binary variable d_{i,j} (i=1, 2, . . . , n−1) and the continuous variable s_{i,j} (i=1, . . . , n) must satisfy are given by the Expressions (4b) to (4e) below, and the scab defect occurrence probability is given by (4f) below.

$$\begin{matrix}[ Math . 10 ] & \\ \begin{matrix}{s}_{1 , j} \leq {d}_{1 , j} \\ {s}_{2 , j} \leq {d}_{1 , j} + {d}_{2 , j} \\ {s}_{3 , j} \leq {d}_{2 , j} + {d}_{3 , j} \\ ⋮ \\ {s}_{n - 1 , j} \leq {d}_{n - 2 , j} + {d}_{n - 1 , j} \\ {s}_{n , j} \leq {d}_{n - 1 , j}\end{matrix} & ( 4 b )\end{matrix}$$

$$\begin{matrix}{s}_{1 , j} \geq 0 \\ {s}_{2 , j} \geq 0 \\ ⋮ \\ {s}_{n , j} \geq 0\end{matrix} \qquad ( 4 c )$$

$${\sum }_{i = 1}^{n} {s}_{i , j} = 1 \qquad ( 4 d )$$

$${\sum }_{i = 1}^{n - 1} {d}_{i , j} = 1 \qquad ( 4 e )$$

$${P}_{LE 1 , j} = {\sum }_{i = 1}^{n} {y}_{i} {s}_{i , j} \qquad ( 4 f )$$

Next, in the evaluation function creation unit (102) illustrated in FIG. 1, an evaluation function is constructed using constraint equations that define the scab defect occurrence probability at the pre-shift lead end and tail end and the post-shift lead end and tail end for all heating furnaces. This may be the sum, or the square, of all heating furnaces (subscript j) for the various scab defect occurrence probabilities P_{LE1,j}, P_{TE1,j}, P_{LE2,j}, P_{TE2,j} listed in Table 5 in correspondence with the overhang amounts in Table 4. For example, the case of the sum is represented by the following Expression (5).

$$\begin{matrix}[ Math . 11 ] & \\ F = {\sum }_{j} ( {P}_{LE 1 , j} + {P}_{TE 1 , j} + {P}_{LE 2 , j} + {P}_{TE 2 , j} ) & ( 5 )\end{matrix}$$

In the optimal condition search unit (103) illustrated in FIG. 1, under the constraint conditions created in the constraint condition creation unit (101), the slab length (L*_{slab}) and the slab charging position for each heating furnace are determined so that the evaluation function created in the evaluation function creation unit (102) is minimized.

By performing the above procedures, the slab length and charging position for each heating furnace that minimize the scab defect occurrence probability can be determined.

### Examples

The content of the present disclosure was applied to a hot rolling mill with three heating furnaces, i.e., a first heating furnace to a third heating furnace, each equipped with a function to shift once.

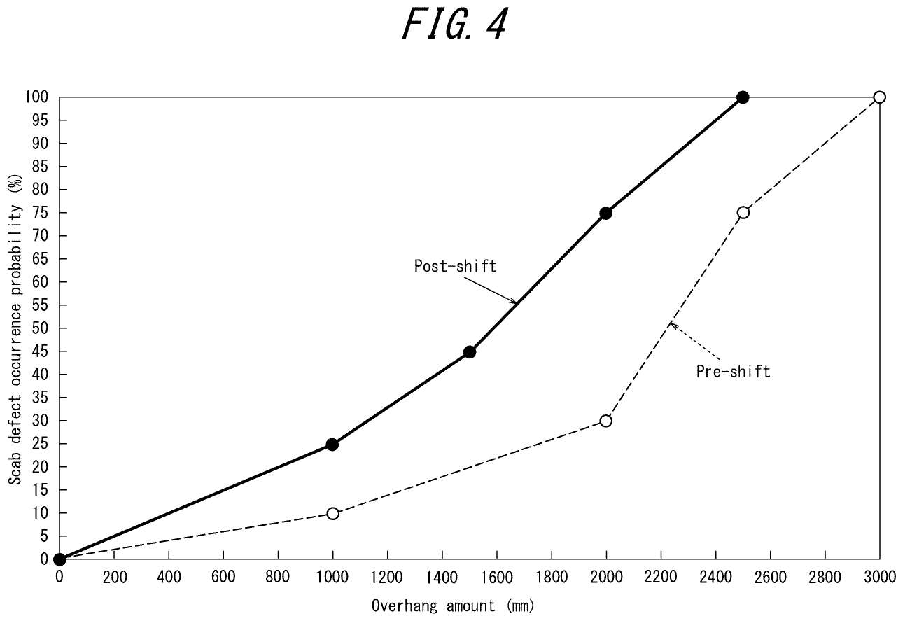

The skid arrangements of each heating furnace in the present embodiment were as illustrated in Table 6 (pre-shift) and Table 7 (post-shift). Also, since the slab reaches a high temperature after the shift, the scab defect occurrence probability is higher for the same pre-shift and post-shift overhang amount. Based on this fact, different models for scab defect occurrence probability are applied before and after the shift, as described for the above piecewise linear model in FIG. 4. Furthermore, the constraints for the slab length to be explored were set in the range of 10000 mm to 12000 mm, considering actual operations.

TABLE 6

| First heating | Second heating | Third heating |
|---|---|---|
| furnace | furnace | furnace |
| −4700 | −4700 | −4800 |
| −3500 | −3600 | −3600 |
| −2100 | −3200 | −2300 |
| −800 | −900 | −1100 |
| 1000 | 1300 | 1100 |
| 2500 | 2300 | 2300 |
| 3800 | 3600 | 3600 |
| 5000 | 5000 | 4800 |

(Note: units [mm])

TABLE 7

| First heating | Second heating | Third heating |
|---|---|---|
| furnace | furnace | furnace |
| −5100 | −5400 | −5600 |
| −3800 | −4800 | −5000 |
| −2500 | −3400 | −3800 |
| −1100 | −2100 | −2500 |
| −200 | −700 | −900 |
| 800 | 500 | 300 |
| 2200 | 1100 | 900 |
| 3400 | 2500 | 2100 |
| 4800 | 3800 | 3400 |
| 5600 | 5200 | 5000 |

(Note: unit [mm])

The lead end overhang amount was defined as the distance between the lead end coordinate of the slab in the heating furnace and the second skid coordinate counted from the lead end in the tail end direction. The tail end overhang amount was defined as the distance between the tail end coordinate of the slab in the heating furnace and the second skid coordinate counted from the tail end in the lead end direction, and the optimal condition search unit was executed. As illustrated in Table 8, the slab length was then determined to be 10940 mm, and the sum of the scab defect occurrence probability at the lead and tail end before and after the shift for all heating furnaces in the table was 385%.

The charging position of the slab (lead end coordinate) was 5720 mm for the first heating furnace, 5340 mm for the second heating furnace, and 5220 mm for the third heating furnace.

TABLE 8

| | First | Second | Third |
|---|---|---|---|
| | heating | heating | heating |
| | furnace | furnace | furnace |
| Lead end coordinate [mm] | 5720 | 5340 | 5220 |
| Tail end coordinate [mm] | −5220 | −5600 | −5720 |
| Slab length (lead end coordinate − tail end | 10940 | 10940 | 10940 |
| coordinate) [mm] | | | |
| Scab defect occurrence probability at lead | 28.4 | 24.8 | 22.4 |
| end (pre-shift) [%] | | | |
| Scab defect occurrence probability at tail | 24.4 | 30.0 | 40.8 |
| end (pre-shift) [%] | | | |
| Scab defect occurrence probability at lead | 23.0 | 47.4 | 64.2 |
| end (post-shift) [%] | | | |
| Scab defect occurrence probability at tail | 41.8 | 20.0 | 18.0 |
| end (post-shift) [%] | | | |

For comparison, Table 9 illustrates the calculation results for the conventional condition where the slab length is 10000 mm, and the charging positions (lead end coordinates) are 5980 mm for the first heating furnace, 4140 mm for the second heating furnace, and 3980 mm for the third heating furnace. The lead end overhang amount was defined as the distance between the lead end coordinate of the slab in the heating furnace and the second skid coordinate counted from the lead end in the tail end direction. Furthermore, the tail end overhang amount was defined as the distance between the tail end coordinate of the slab in the heating furnace and the second skid coordinate counted from the tail end in the lead end direction. The total scab defect occurrence probability for all heating furnaces in the table was 499%. Since this example is higher compared to the example according to the present embodiment, it can be seen that a reduction in the occurrence of scab defects can be expected by following the present embodiment.

TABLE 9

| | First | Second | Third |
|---|---|---|---|
| | heating | heating | heating |
| | furnace | furnace | furnace |
| Lead end coordinate [mm] | 5980 | 4140 | 3980 |
| Tail end coordinate [mm] | −4020 | −5860 | −6020 |
| Slab length (lead end coordinate − tail end | 10000 | 10000 | 10000 |
| coordinate) [mm] | | | |
| Scab defect occurrence probability at lead | 46.2 | 26.8 | 23.6 |
| end (pre-shift) [%] | | | |
| Scab defect occurrence probability at tail | 28.4 | 53.4 | 67.8 |
| end (pre-shift) [%] | | | |
| Scab defect occurrence probability at lead | 32.2 | 53.4 | 67.8 |
| end (post-shift) [%] | | | |
| Scab defect occurrence probability at tail | 46.2 | 27.4 | 25.8 |
| end (post-shift) [%] | | | |

The lead end overhang amount was also defined as the distance between the lead end coordinate of the slab in the heating furnace and the first skid coordinate counted from the lead end in the tail end direction. Furthermore, the tail end overhang amount was defined as the distance between the tail end coordinate of the slab in the heating furnace and the first skid coordinate counted from the tail end in the lead end direction. At this time, Table 10 illustrates the result of determining the scab defect occurrence probability due to the second skid contact at the lead end when calculating the slab length and charging position that minimize the total lead end overhang amount.

In this case, the slab length was 10340 mm, and the total scab defect occurrence probability for all heating furnaces in the table was 425%. Since this example is also higher compared to the example according to the present embodiment, it can be seen that a reduction in the occurrence of scab defects can be expected by following the present embodiment.

TABLE 10

| | First | Second | Third |
|---|---|---|---|
| | heating | heating | heating |
| | furnace | furnace | furnace |
| Lead end coordinate [mm] | 5120 | 5320 | 5120 |
| Tail end coordinate [mm] | −5220 | −5020 | −5220 |
| Slab length (lead end coordinate − tail end | 10340 | 10340 | 10340 |
| coordinate) [mm] | | | |
| Scab defect occurrence probability at lead | 16.4 | 24.4 | 20.4 |
| end (pre-shift) [%] | | | |
| Scab defect occurrence probability at tail | 24.4 | 18.4 | 22.4 |
| end (pre-shift) [%] | | | |
| Scab defect occurrence probability at lead | 58.2 | 46.2 | 58.2 |
| end (post-shift) [%] | | | |
| Scab defect occurrence probability at tail | 41.8 | 52.2 | 41.8 |
| end (post-shift) [%] | | | |

1. A method of determining a slab length and a charging position of a slab in a walking-beam heating furnace, the method comprising:
in determining a length of a slab to be charged into at least one walking-beam heating furnace and a charging position of the slab using mixed integer programming,
using, as constraint conditions,
a constraint equation defining an overhang amount,
a constraint equation defining a scab defect occurrence probability corresponding to the overhang amount from a predetermined model that defines a relationship between the overhang amount and a probability of occurrence of a scab defect occurring at a skid portion, and
a constraint equation defining upper and lower limits of slab length,
further using an evaluation function that uses a constraint equation defining the scab defect occurrence probability, and
determining the length of the slab and the charging position of the slab to minimize the evaluation function under the constraint conditions, wherein
as the overhang amount,
a lead end overhang amount, defined as a distance between a lead end coordinate of the slab in the heating furnace and a second skid coordinate counted from a lead end in a tail end direction, and
a tail end overhang amount, defined as a distance between a tail end coordinate of the slab in the heating furnace and a second skid coordinate counted from a tail end in a lead end direction, are used.

2. The method of determining a slab length and a charging position of a slab in a walking-beam heating furnace according to claim 1, wherein
in a case in which the walking-beam heating furnace includes a shift function,
as the overhang amount,
a pre-shift lead end overhang amount, defined as a distance between the lead end coordinate of the slab in the heating furnace and a second pre-shift skid coordinate counted from the lead end in the tail end direction,
a pre-shift tail end overhang amount, defined as a distance between the tail end coordinate of the slab in the heating furnace and a second pre-shift skid coordinate counted from the tail end in the lead end direction,
a post-shift lead end overhang amount, defined as a distance between the lead end coordinate of the slab in the heating furnace and a second post-shift skid coordinate counted from the lead end in the tail end direction, and
a post-shift tail end overhang amount, defined as a distance between the tail end coordinate of the slab in the heating furnace and a second post-shift skid coordinate counted from the tail end in the lead end direction, are used.

3. The method of determining a slab length and a charging position of a slab in a walking-beam heating furnace according to claim 1, wherein in a case in which the at least one walking-beam heating furnace comprises a plurality of walking-beam heating furnaces, an equality constraint on the slab length for the heating furnaces is added to the constraint conditions.

4. The method of determining a slab length and a charging position of a slab in a walking-beam heating furnace according to claim 1, wherein the constraint equation defining the scab defect occurrence probability is selected according to a maximum end-point temperature of the slab obtained in advance.

5. The method of determining a slab length and a charging position of a slab in a walking-beam heating furnace according to claim 1, wherein the evaluation function is a sum of a square of each scab defect occurrence probability.

6. The method of determining a slab length and a charging position of a slab in a walking-beam heating furnace according to claim 1, wherein the evaluation function is a sum of each scab defect occurrence probability.

7. The method of determining a slab length and a charging position of a slab in a walking-beam heating furnace according to claim 2, wherein in a case in which the at least one walking-beam heating furnace comprises a plurality of walking-beam heating furnaces, an equality constraint on the slab length for the heating furnaces is added to the constraint conditions.

8. The method of determining a slab length and a charging position of a slab in a walking-beam heating furnace according to claim 2, wherein the constraint equation defining the scab defect occurrence probability is selected according to a maximum end-point temperature of the slab obtained in advance.

9. The method of determining a slab length and a charging position of a slab in a walking-beam heating furnace according to claim 2, wherein the evaluation function is a sum of a square of each scab defect occurrence probability.

10. The method of determining a slab length and a charging position of a slab in a walking-beam heating furnace according to claim 2, wherein the evaluation function is a sum of each scab defect occurrence probability.

11. The method of determining a slab length and a charging position of a slab in a walking-beam heating furnace according to claim 3, wherein the constraint equation defining the scab defect occurrence probability is selected according to a maximum end-point temperature of the slab obtained in advance.

12. The method of determining a slab length and a charging position of a slab in a walking-beam heating furnace according to claim 3, wherein the evaluation function is a sum of a square of each scab defect occurrence probability.

13. The method of determining a slab length and a charging position of a slab in a walking-beam heating furnace according to claim 3, wherein the evaluation function is a sum of each scab defect occurrence probability.

14. The method of determining a slab length and a charging position of a slab in a walking-beam heating furnace according to claim 4, wherein the evaluation function is a sum of a square of each scab defect occurrence probability.

15. The method of determining a slab length and a charging position of a slab in a walking-beam heating furnace according to claim 4, wherein the evaluation function is a sum of each scab defect occurrence probability.

16. The method of determining a slab length and a charging position of a slab in a walking-beam heating furnace according to claim 7, wherein the constraint equation defining the scab defect occurrence probability is selected according to a maximum end-point temperature of the slab obtained in advance.

17. The method of determining a slab length and a charging position of a slab in a walking-beam heating furnace according to claim 7, wherein the evaluation function is a sum of a square of each scab defect occurrence probability.

18. The method of determining a slab length and a charging position of a slab in a walking-beam heating furnace according to claim 7, wherein the evaluation function is a sum of each scab defect occurrence probability.

19. The method of determining a slab length and a charging position of a slab in a walking-beam heating furnace according to claim 8, wherein the evaluation function is a sum of a square of each scab defect occurrence probability.

20. The method of determining a slab length and a charging position of a slab in a walking-beam heating furnace according to claim 8, wherein the evaluation function is a sum of each scab defect occurrence probability.
